(19) United States
(12) Patent Application Publication
(10) Pub. No.: US 2017/0316011 A1
(43) Pub. Date: Nov. 2, 2017

(54) METHOD AND APPARATUS FOR SEARCHING RESOURCE

(71) Applicant: Beijing Xiaomi Mobile Software Co., Ltd., Beijing (CN)

(72) Inventors: Ming LIU, Beijing (CN); Le WANG, Beijing (CN); Wendi HOU, Beijing (CN); Chen ZHONG, Beijing (CN); Fuye WANG, Beijing (CN)

(73) Assignee: Beijing Xiaomi Mobile Software Co., Ltd.

(21) Appl. No.: 15/495,078

(22) Filed: Apr. 24, 2017

(30) Foreign Application Priority Data
Apr. 27, 2016 (CN) 201610274210.9

(51) Int. Cl. G06F 17/30

(52) U.S. Cl. CPC G06F 17/3053; G06F 17/30554; G06F 17/30864

(57) ABSTRACT

A method for searching a resource, is provided. The method is applied in a terminal and includes receiving at least one search character input by a user when an input program is called by an application program running in a foreground in the terminal, and sending the at least one search character to a server. The server is configured for selecting from a resource library relevant information of a resource that matches the at least one search character, and sending the relevant information to the input program. The resource library is configured for storing the resource and the relevant information of the resource, and the relevant information is configured for the user to identify and acquire the resource. The method further includes receiving the relevant information from the server and providing the relevant information to the user.

### CROSS-REFERENCE TO RELATED APPLICATION

This application is based upon and claims priority to Chinese Patent Application No. 201610274210.9, filed Apr. 27, 2016, the entire contents of which are incorporated herein by reference.

### TECHNICAL FIELD

The present disclosure generally relates to the technical field of computer, and more particularly, to a method and apparatus for searching a resource.

### BACKGROUND

A user may input characters in a search bar provided by an application program in a terminal, to search relevant resources in the application program. For example, the user may input characters in a search bar of an application store to search for an application program, input characters in a search bar of a music application program to search for music, or input characters in a video application program to search for a video.

### SUMMARY

According to a first aspect of the present disclosure, a method for searching a resource is provided. The method is applied in a terminal and includes receiving at least one search character input by a user when an input program is called by an application program running in a foreground in the terminal, and sending the at least one search character to a server. The server is configured for selecting from a resource library relevant information of a resource that matches the at least one search character, and sending the relevant information to the input program. The resource library is configured for storing the resource and the relevant information of the resource, and the relevant information is configured for the user to identify and acquire the resource. The method further includes receiving the relevant information from the server and providing the relevant information to the user.

According to a second aspect of the present disclosure, a method for searching a resource is provided. The method is applied in a server and includes receiving at least one search character sent by an input program in a terminal. The at least one search character is received when the input program is called by an application program running in a foreground in the terminal. The method further includes selecting relevant information of a resource that matches the at least one search character from a resource library. The resource library being configured for storing the resource and the relevant information of the resource, and the relevant information is configured for a user to identify and acquire the resource. The method further includes sending the relevant information to the input program. The input program is configured for providing the relevant information to the user.

According to a third aspect of the present disclosure, a terminal is provided. The terminal includes a processor and a memory for storing instructions executable by the processor. The processor is configured to receive at least one search character input by a user when an input program is called by an application program running in a foreground in the terminal, and to send the at least one search character to a server. The server is configured for selecting from a resource library relevant information of a resource that matches the at least one search character, and sending the relevant information to the input program. The resource library is configured for storing the resource and the relevant information of the resource, and the relevant information is configured for the user to identify and acquire the resource. The processor is further configured to receive the relevant information from the server and to provide the relevant information to the user.

According to a fourth aspect of the present disclosure, a server is provided. The server includes a processor and a memory for storing instructions executable by the processor. The processor is configured to receive at least one search character sent by an input program in a terminal. The at least one search character is received when the input program is called by an application program running in a foreground in the terminal. The processor is further configured to select relevant information of a resource that matches the at least one search character from a resource library. The resource library is configured for storing the resource and the relevant information of the resource, and the relevant information is configured for a user to identify and acquire the resource. The processor is further configured to send the relevant information to the input program. The input program is configured for providing the relevant information to the user.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a schematic diagram of a system for searching a resource, according to an exemplary embodiment of the present disclosure.

FIG. 2 is a flow chart of a method for searching a resource, according to an exemplary embodiment of the present disclosure.

FIG. 3A is a flow chart of a method for searching a resource, according to another exemplary embodiment of the present disclosure.

FIG. 3B is a schematic diagram of an input program displaying relevant information, according to an exemplary embodiment of the present disclosure.

FIG. 3C is a schematic diagram of an input program displaying relevant information, according to another exemplary embodiment of the present disclosure.

FIG. 4 is a block diagram of an apparatus for searching a resource, according to an exemplary embodiment of the present disclosure.

FIG. 5 is a block diagram of an apparatus for searching a resource, according to another exemplary embodiment of the present disclosure.

FIG. 6 is a block diagram of an apparatus for searching a resource, according to yet another exemplary embodiment of the present disclosure.

FIG. 7 is a block diagram of an apparatus for searching a resource, according to still yet another exemplary embodiment of the present disclosure.

FIG. 8 is a block diagram of a terminal, according to an exemplary embodiment of the present disclosure.

FIG. 9 is a block diagram of a server, according to an exemplary embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely exemplary apparatuses and methods consistent with aspects related to the invention as recited in the appended claims.

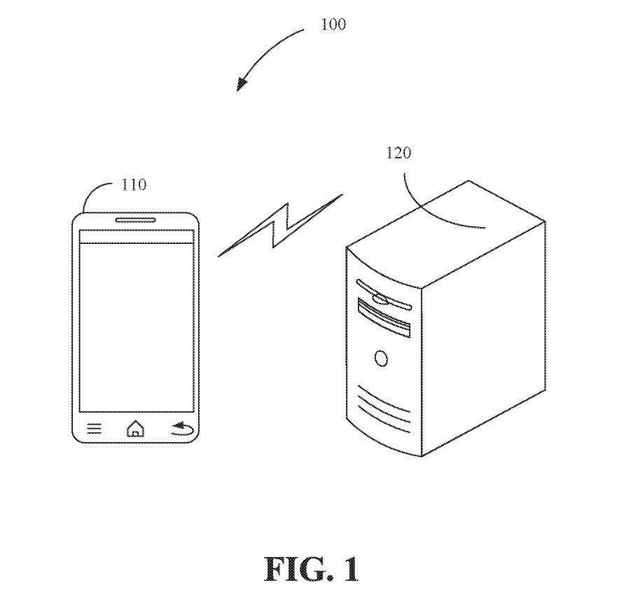

FIG. 1 is a schematic diagram of a system 100 for searching a resource, according to an exemplary embodiment of the present disclosure. As shown in FIG. 1, the system 100 may include a terminal 110 and a server 120.

The terminal 110 is installed with an input program. The input program is configured for a user to input characters in the terminal 110. The terminal 110 may be any device having an input program installed thereon, which includes, but is not limited to, a mobile phone, a tablet, or a personal computer (PC).

The server 120 communicates with the terminal 110 via a communication network. The communication network may include, but is not limited to, a wireless network or a wired network.

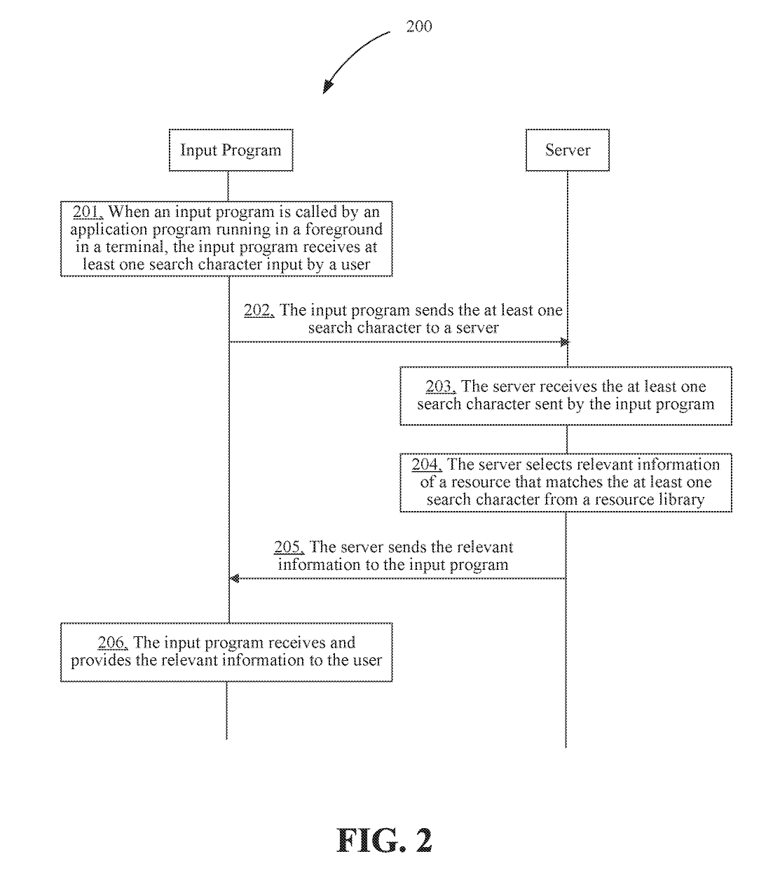

FIG. 2 is a flow chart of a method 200 for searching a resource, according to an exemplary embodiment of the present disclosure. The method 200 may be applied to the system 100 for searching a resource (FIG. 1). As shown in FIG. 2, the method 200 may include the following steps.

In step 201, when an input program is called by an application program, e.g., an application program running in a foreground, in a terminal, the input program receives at least one search character, e.g., input by a user.

In step 202, the input program sends the at least one search character to a server.

In step 203, the server receives the at least one search character sent by the input program.

In step 204, the server selects relevant information of a resource that matches the at least one search character from a resource library.

The resource library is configured for storing the resource and the relevant information of the resource. The relevant information is configured for the user to identify and acquire the resource.

In step 205, the server sends the relevant information to the input program.

In step 206, the input program receives and provides the relevant information to the user.

In some embodiments, the steps 201, 202 and 206 may be separately implemented as a method on the input program side. In some embodiments, the steps 203 to 205 may be separately implemented as a method on the server side.

In the method 200 for searching a resource provided by the present disclosure, at least one search character is received (e.g., the at least one search character is input by a user) when an input program is called by an application program running in a foreground in a terminal. A server selects relevant information of a resource that matches the at least one search character from a resource library. The input program receives and provides the relevant information to the user. As a result, the user can find a resource that is to be searched, by only inputting at least one search character when searching the resource. Thus, a complete name of the resource is not required for searching the resource in a search bar of the application program. This may solve the problem of low resource searching efficiency due to that only when a user inputs a complete name of a resource in a search bar of an application program, the server sends the resource that matches the name to the application program. The resource searching efficiency is thus improved.

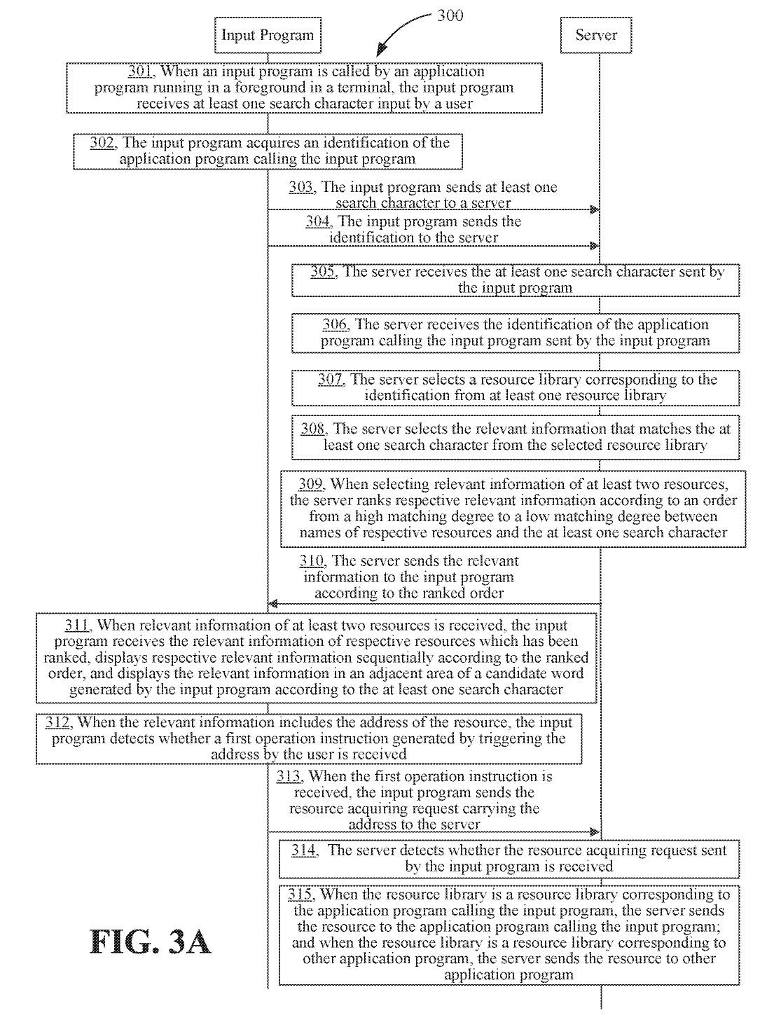

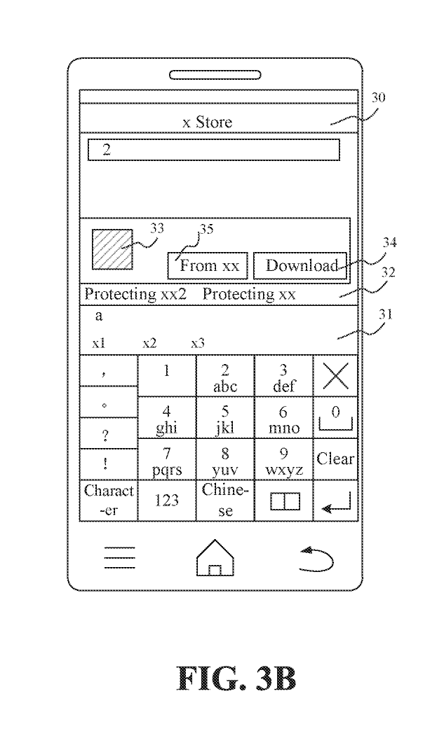

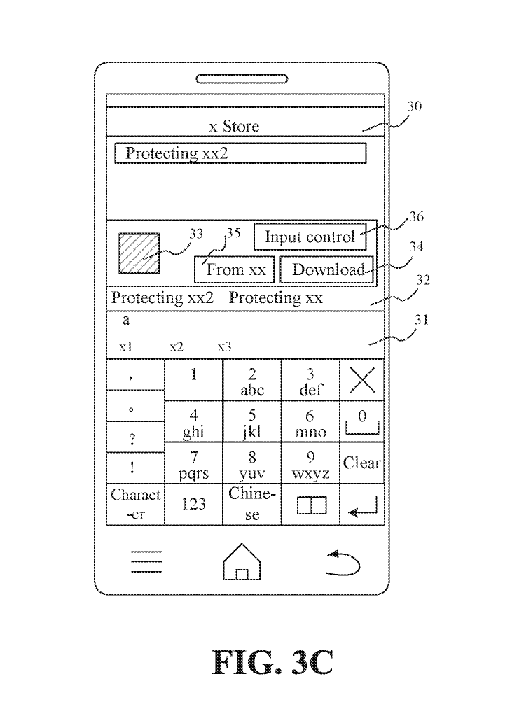

FIG. 3A is a flow chart of a method 300 for searching a resource, according to another exemplary embodiment of the present disclosure. The method 300 may be applied in a terminal. As shown in FIG. 3A, the method 300 may include the following steps.

In step 301, when an input program is called by an application program running in a foreground in a terminal, the input program receives at least one search character (e.g., input by a user).

When searching a resource via an application program in the terminal, the user activates the application program and enables the application program to run in the foreground. The user executes a triggering operation in a search box of the application program. After receiving the triggering operation, the application program is aware that the user needs to search the resource. At this time, by the application program calling the input program, the user may input at least one search character via the input program, and accordingly, the input program receives the at least one search character.

In some embodiments, after activating the application program, the user may not execute the triggering operation. Instead, the application program directly calls the input program, and then the user inputs at least one search character in the input program.

The input program is a program installed in the terminal for the user to input characters in the terminal. The input program may be an input method. In some embodiments, the input program may provide at least two input manners, such as a 9-key number manner and a 26-key letter manner.

The search character is used for generating a search letter, or a search word. When the user sets the input manner of the input program to be the 9-key number manner, the form of the search character is number. When the user sets the input manner of the input program to be the 26-key letter manner, the form of the search character is letter.

For example, when the user desires to search for an application program in an application store, after the application store is opened, the user executes a click operation in a search box of the application store. At this time, the application store calls an input program, and the user sets an input manner of the input program to be the 9-key number. Accordingly, the at least one search character input by the user is at least one number. And the input program receives the at least one number.

In step 302, the input program acquires an identification of the application program calling the input program.

The identification of the application program is configured for uniquely identifying the application program. In some embodiments, the identification may be a package name of the application program.

In some embodiments, the step 302 may be executed before the step 301, after the step 301, or simultaneously with the step 301. In the present disclosure, the timing of acquiring the identification of the application program is not limited.

In step 303, the input program sends the at least one search character to a server.

In step 304, the input program sends the identification to the server.

The step 304 may be executed before the step 303, after the step 303, or simultaneously with the step 303, which is not limited by the present disclosure.

In step 305, the server receives the at least one search character sent by the input program.

In step 306, the server receives the identification of the application program calling the input program sent by the input program.

The step 306 may be executed before the step 305, after the step 305, or simultaneously with the step 305, which is not limited by the present disclosure.

In step 307, the server selects a resource library corresponding to the identification from at least one resource library.

The resource library is configured for storing a resource and relevant information of the resource. The relevant information is used for a user to identify and acquire the resource. The relevant information may include at least a name of the resource and an address of the resource. The address of the resource may include a download address of the resource and an address of the resource library to which the resource belongs. The download address of the resource is configured to provide an entrance for a user to download the resource. The address of the resource library to which the resource belongs is configured for notifying the user of an application program corresponding to the resource library.

In some embodiments, if the user searches a resource in a browser, an address of the resource is a link of the search result. In this case, when the user triggers the link, the browser displays the search result in a current display interface.

In some embodiments, the relevant information may further include, but is not limited to, an icon of the resource, a size of the resource, or the like.

In some embodiments, the server stores at least one resource library. After receiving the at least one search character by the server, the server searches for relevant information of the resource that matches the at least one search character from all the resource libraries. In this case, since the server needs to traverse all the resource libraries, the search speed may be slow.

In some embodiments, the server pre-stores a corresponding relationship between resource libraries and identifications of application programs. After receiving an identification of an application program, the server selects a resource library corresponding to the identification of the application program according to the corresponding relationship, and searches for the relevant information of the resource that matches the at least one search character from the selected resource library. In this case, the server only needs to traverse one resource library, which improves a speed of searching the resource.

For example, a corresponding relationship pre-stored in the server may be as shown in the following Table 1. When the identification of the application program received by the server is xxshangdian1, the server selects relevant information of the resource that matches the search character from the resource library 1 corresponding to xxshangdian1. In this case, it is unnecessary for the server to select the relevant information from all the resource libraries, which improves a speed of searching the resource.

TABLE 1
A corresponding relationship pre-stored in a server.

| Identification of application program | Resource library |
|---|---|
| xxshangdian1 | Resource library 1 |
| xxshangdian2 | Resource library 2 |
| xxshipin | Resource library 3 |
| xxyinyue | Resource library 4 |
| xxliulanqi | Resource library 5 |

In step 308, the server selects the relevant information that matches the at least one search character from the selected resource library.

Before selecting the relevant information that matches the at least one search character from the selected resource library, the server may encode the names of the stored resources according to a form of search character. For example, when the form of the search character is number, the names of the resources are encoded according to an input sequence of the 9-key number manner. And when the form of the search character is letter, the names of the resources are encoded according to an input sequence of the 26-key letter manner. The server selects the encoded relevant information with a prefix that matches the at least one search character from the selected resource library.

For example, when selecting the relevant information of the resource from the resource library 1 by the server, the search character received by the server is a letter corresponding to a number key 9, and the names of the resources in the resource library 1 are encoded according to the input sequence of the 9-key number manner. If a resource with a code of “934x” exists, “Ax” of this resource is used as the relevant information of the resource that matches, where “A” is, e.g., a Chinese character corresponding to the code “934” and “x” is, e.g., a Chinese character predicted by the server following the character “A”.

In some embodiments, the server may also encode the names of the resources according to the above two input manners before receiving the at least one search character. In this case, after receiving the at least one search character, the server may directly select the relevant information of the resource that matches the at least one search character from the resource library without the encoding procedure, which improves the efficiency of resource searching. In the present disclosure, the timing of encoding the relevant information of the resource by the server is not limited.

When there is no relevant information that matches the at least one search character in the resource library selected by the server, a resource library corresponding to another application program, which is of a same type with the original application program that calls the input program, is determined according to the identification of the original application program. The relevant information that matches the at least one search character is selected from the determined resource library.

For example, based on the corresponding relationship shown in the above Table 1, the application program corresponding to the identification received by the server is xxshangdian 1, then the server selects the relevant information of the resource that matches the at least one search character from the resource library 1. And if the relevant information of the resource that matches the at least one search character does not exist in the resource library 1, the server determines a resource library corresponding to an application program xxshangdian 2 having the same type according to the identification, i.e., the resource library 2. In this case, the server selects the relevant information that matches the at least one search character from the resource library 2.

In the present embodiment, when there is no relevant information that matches the at least one search character in the resource library selected by the server, a resource library corresponding to another application program of the same type is searched. As such, the resource searched by the server is not limited to the resource library corresponding to the application program calling the input program, the range of resource searching is increased, and the success rate of resource searching is improved.

In step 309, when relevant information of at least two resources is selected, the server ranks the selected relevant information according to an order from a high matching degree to a low matching degree between the names of respective resources and the at least one search character.

The matching degree may be a search hot degree or a download hot degree of the resource, which is not limited by the present disclosure.

In step 310, the server may send the relevant information to the input program according to the ranked order.

The larger a matching degree with the search character is, the larger the possibility that a resource is the resource searched by the user. The server ranks the respective relevant information according to an order from a high matching degree to a low matching degree between names of respective resources and the at least one search character and sends the respective relevant information to the input program according to the ranked order. As a result, the input program first receives the relevant information of the resource having a higher matching degree from the resources matching with the search character. Accordingly, the possibility that a resource corresponding to the relevant information received by the input program is the resource desired by the user, is improved.

In step 311, when relevant information of at least two resources is received, the input program receives the relevant information of respective resources which has been ranked, displays the relevant information sequentially according to the ranked order, and displays the relevant information in an adjacent area of a candidate word generated by the input program according to the at least one search character.

Referring to a schematic diagram shown in FIG. 3B in which the input program displays the relevant information, the input manner set by the user is the 9-key number manner. After the application program 30 calls the input program, a number 2 is input via the input program. And candidate words 31, represented by “x1”, “x2”, and “x3”, corresponding to the number 2 appear at an upper side of an input panel of the input program. The relevant information received by the input program may include names 32 “Protecting xx2” and “Protecting xx” of a resource, an icon 33 of the resource, a download address 34 of the resource, an address 35 of a resource library to which the resource belongs, wherein the above relevant information is all displayed in a region near the candidate word. The “Protecting xx” may be a name of an online game of a first version, and the “Protecting xx2” may be a name of the online game of a second version.

In the exemplary embodiment, the displaying sequence of the relevant information is: the icon of the resource and the name of the resource. And the relevant information is displayed at an upper side of the candidate word list. The displaying sequence of the relevant information, and the positional relationship between the relevant information and the list of the candidate words are not limited in the present disclosure.

In some embodiments, when an input control is also displayed in a display area of the relevant information, it is detected whether a second operation instruction generated by triggering the input control by the user is received. And when the second operation instruction is received, the at least one search character is updated by using the name of the resource.

The second operation instruction is configured for instructing the input program to input the name of the resource into the search bar of the application program calling the input program. The search bar includes at least one search character.

For example, in a schematic diagram shown in FIG. 3C in which the input program displays the relevant information, an input control 36 is also displayed in the display area of the relevant information. After the user triggers the input control, the search character 2 in the search bar is replaced by the name of the resource “Protecting xx2”.

If the address of the resource library to which the resource belongs displayed by the input program indicates another application program, when the user acquires the resource, the terminal may jump to the other application program to download the resource. If the other application program is not installed in the terminal, the terminal needs to download the other application program at first, and then jump to the other application program for downloading the resource. When the resource in the other application program is unsafe, it is possible that the user does not want to download the resource from the resource library corresponding to the other application program, instead, the user desires to download the resource from the resource library corresponding to the application program calling the input program. In this case, an input control may be provided in the display area of the relevant information. If the user triggers the input control, the input program inputs the name of the resource into the search bar. The server searches the resource in the resource library corresponding to the application program. In addition, since the at least one search character may be updated by using the name of the resource, instead of inputting a complete name of the resource and then inputting it into the search bar, the input efficiency may be improved.

In step 312, when the relevant information includes the address of the resource, the input program detects whether a first operation instruction generated by triggering the address by the user is received.

The first operation instruction is configured for instructing the input program to generate a resource acquiring request. The resource acquiring request is for requesting a resource from the server.

For example, in the schematic diagram shown in FIG. 3C in which the input program displays the relevant information, the input program detects whether a first operation instruction generated by triggering the download address 34 by the user is received.

In step 313, when the first operation instruction is received, the input program sends the resource acquiring request carrying the address to the server.

If the input program receives the first operation instruction, it indicates that the user needs to download the resource corresponding to the displayed relevant information. In this case, the input program sends the request acquiring request carrying the address to the server.

For example, in the schematic diagram shown in FIG. 3C in which the input program displays the relevant information, the user triggers the download address 34 of the resource. The input program receives the first operation instruction and sends the resource acquiring request carrying the download address 34 and the address 35 of the resource library to the server.

In step 314, the server detects whether the resource acquiring request sent by the input program is received.

In step 315, when the resource library is a resource library corresponding to the application program calling the input program, the server sends the resource to the application program calling the input program; and when the resource library is a resource library corresponding to another application program, the server sends the resource to the other application program.

When it is detected by the server that the resource acquiring request sent by the input program is received, the resource is sent to the application program corresponding to the resource library according to the download address and the address of the resource library to which the resource belongs. In this case, when the resource library is a resource library corresponding to the application program calling the input program, the server sends the resource to the application program calling the input program. The application program calling the input program receives the resource. For example, in the schematic diagram shown in FIG. 3C in which the input program displays the relevant information, the address 35 of the resource library indicates the application program 30. The application program 30 receives the resource sent by the server. When the resource library is a resource library corresponding to another application program, the server sends the resource to the other application program. At this time, the terminal starts and jumps to the other application program indicated by the address of the resource library. The other application program receives the resource sent by the server. For example, in the schematic diagram shown in FIG. 3C in which the input program displays the relevant information, the address 35 of the resource library does not indicate the application program 30. At this time, the terminal starts and jumps to other application program indicated by the address 35 of the resource library, and the other application program receives the resource sent by the server.

The steps 301 to 304 and 311 to 313 may be separately implemented as a method on the input program side, and the steps 305 to 310 and 314 to 315 may be separately implemented as a method on the server side, which are not limited in the present disclosure.

In the method 300 for searching a resource provided by the present disclosure, when an input program is called by an application program running in a foreground in a terminal, at least one search character input by a user is received. Relevant information of a resource that matches the at least one search character is selected by a server from a resource library. The relevant information is received and provided to the user. As a result, the user can find the resource by only inputting at least one search character when searching the resource, without inputting a complete name of the resource in a search bar of the application program. This solves the problem of low resource searching efficiency due to that only when the user inputs a complete name of the resource in a search bar of the application program, the server sends the resource that matches the name to the application program. Accordingly, the effect of improving the resource searching efficiency is achieved.

In addition, by displaying the relevant information in an adjacent area of a candidate word, the user can conveniently operate the relevant information.

In addition, by acquiring an identification of the application program calling the input program and sending the identification to the server, it is unnecessary for the server to search the relevant information of the resource from all the resource libraries. Instead, the server only needs to select the resource library corresponding to the identification from at least one resource library, and select the relevant information that matches the search character from the selected resource library, which reduces the resource consumed by searching the relevant information that matches the search character via the server.

In addition, the resources that match the search character according to the matching degrees are ranked via the server. The respective relevant information according to the ranked order is displayed via the input program. The larger the matching degree with the search character is, the larger the possibility that a resource is the resource searched by the user. As such, the accuracy of displaying the relevant information can be improved by giving a high priority to displaying the relevant information of the resource having a higher matching degree.

In addition, when there is no relevant information that matches the search character in the selected resource library, a resource library corresponding to another application program which belongs to the same type with this application program is determined according to the identification. The relevant information that matches the search character is selected from the determined resource base. In this way, when there is no resource in the resource library corresponding to the application program calling the input program, a resource library corresponding to another application program having the same type may be searched. This may solve the problem that the server does not find the relevant information of the resource when there is no resource in the resource library corresponding to the application program calling the input program. Accordingly the effects of searching the resources across platforms may be achieved and thus providing more resources to the user.

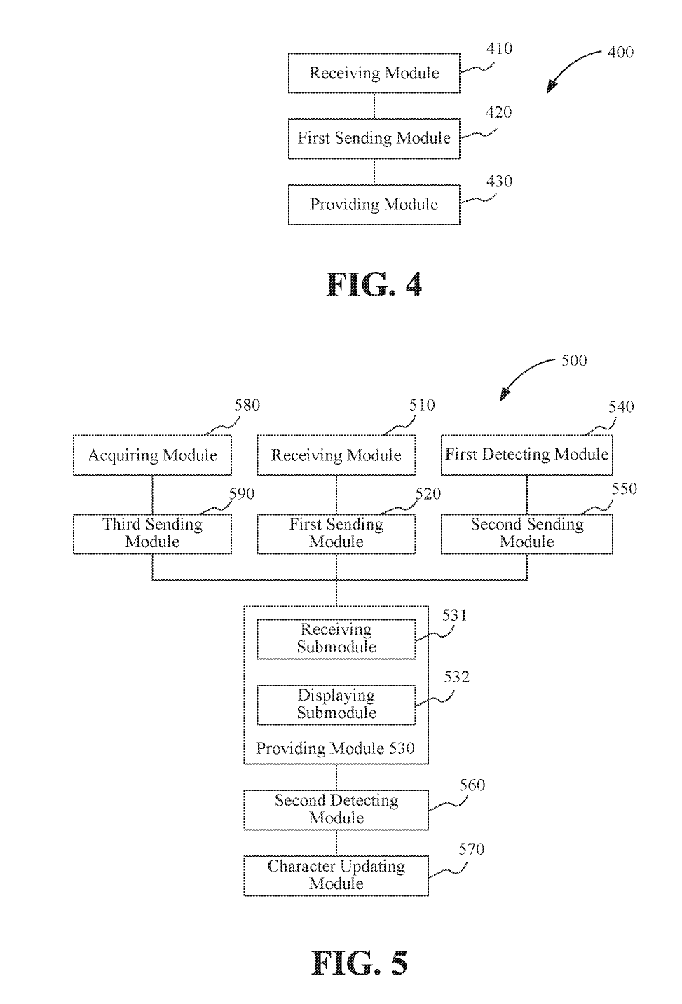

FIG. 4 is a block diagram of an apparatus 400 for searching a resource, according to an exemplary embodiment of the present disclosure. The apparatus 400 may be applied in a terminal installed with an input program. As shown in FIG. 4, the apparatus 400 may include a receiving module 410, a first sending module 420, and a providing module 430.

The receiving module 410 is configured to receive at least one search character input by a user when the input program is called by an application program running in a foreground in the terminal.

The first sending module 420 is configured to send the at least one search character received by the receiving module 410 to a server. The server is configured for selecting relevant information of a resource that matches the at least one search character from a resource library, and to send the relevant information to the input program. The resource library is configured for storing the resource and the relevant information of the resource. The relevant information is configured for the user to identify and acquire the resource.

The providing module 430 is configured to receive and provide the relevant information to the user.

In the apparatus 400 for searching a resource provided by the present disclosure, at least one search character input by a user is received when an input program is called by an application program running in a foreground in a terminal. Relevant information of a resource that matches the at least one search character is selected by a server from a resource library. The relevant information is received and provided to the user. The user can find the resource by only inputting at least one search character, without inputting a complete name of the resource in a search bar of the application program. This solves the problem of low resource searching efficiency due to that only when the user inputs a complete name of the resource in a search bar of the application program while searching resources, the server sends the resource that matches the name to the application program. Accordingly, the effect of improving the resource searching efficiency may be achieved.

FIG. 5 is a block diagram of an apparatus 500 for searching a resource, according to another exemplary embodiment of the present disclosure. As shown in FIG. 5, the apparatus 500 may include a receiving module 510, a first sending module 520, and a providing module 530.

The receiving module 510 is configured to receive at least one search character input by a user when an input program is called by an application program running in a foreground in a terminal.

The first sending module 520 is configured to send the at least one search character received by the receiving module 510 to a server. The server is configured for selecting relevant information of a resource that matches the at least one search character from a resource library. The relevant information is sent to the input program. The resource library is configured for storing the resource and the relevant information of the resource. The relevant information is configured for the user to identify and acquire the resource.

The providing module 530 is configured to receive and provide the relevant information to the user.

In some embodiments, the providing module 530 may include a receiving submodule 531 and a displaying submodule 532.

The receiving submodule 531 is configured to receive the relevant information.

The displaying submodule 532 is configured to display the relevant information received by the receiving submodule 531 in an interface of the input program.

In some embodiments, the displaying submodule 532 may be further configured to display the relevant information in an adjacent area of a candidate word generated by the input program according to the at least one search character. The relevant information may include at least a name of the resource and an address of the resource.

In some embodiments, the apparatus 500 may further include a first detecting module 540 and a second sending module 550.

The first detecting module 540 is configured to, when the relevant information includes the address of the resource, detect whether a first operation instruction generated by triggering the address by the user is received.

The second sending module 550 is configured to, when the first detecting module 540 detects that the first operation instruction is received, send a resource acquiring request carrying the address to the server. The resource acquiring request is configured for requesting the resource from the server.

In some embodiments, the apparatus 500 may further include a second detecting module 560 and a character updating module 570.

The second detecting module 560 is configured to, when an input control is also displayed in a display area of the relevant information, detect whether a second operation instruction generated by triggering the input control by the user is received.

The character updating module 570 is configured to, when the second detecting module 560 detects that the second operation instruction is received, update the at least one search character by using the name of the resource.

In some embodiments, the displaying submodule 532 may further be configured to: when relevant information of at least two resources is received, receive the relevant information of respective resources which has been ranked, and to display respective relevant information sequentially according to a ranked order. The ranked order is obtained by ranking respective relevant information via the server according to an order from a high matching degree to a low matching degree between the names of respective resources and the at least one search character.

In some embodiments, the apparatus 500 may further include an acquiring module 580 and a third sending module 590.

The acquiring module 580 is configured to acquire an identification of the application program calling the input program.

The third sending module 590 is configured to send the identification acquired by the acquiring module 580 to the server. The server is configured for selecting a resource library corresponding to the identification from at least one resource library, and selecting the relevant information that matches the at least one search character from the selected resource library.

In the apparatus 500 for searching a resource provided by the present disclosure, at least one search character input by a user is received when an input program is called by an application program running in a foreground in a terminal. The server relevant information of a resource that matches the at least one search character is selected by the server from a resource library. the relevant information is received and provided to the user. The user can find the resource by only inputting at least one search character when searching resources, without inputting a complete name of the resource in a search bar of the application program. This solves the problem of low resource searching efficiency due to that only when the user inputs a complete name of the resource in a search bar of the application program, the server sends the resource that matches the name to the application program. Accordingly, the effect of improving the resource searching efficiency may be achieved.

In addition, by displaying the relevant information in an adjacent area of a candidate word, the user can conveniently operate the relevant information.

In addition, by acquiring an identification of the application program calling the input program and sending the identification to the server, it is unnecessary for the server to search the relevant information of the resource from all the resource libraries, instead, the server only needs to select the resource library corresponding to the identification from at least one resource library, and select the relevant information that matches the search character from the selected resource library. As a result, it reduces the resource consumed by searching the relevant information that matches the search character via the server.

In addition, the resources that match the search character according to the matching degrees are ranked via the server, and the respective relevant information according to the ranked order is displayed via the input program. The larger the matching degree with the search character is, the larger the possibility that the resource is the resource searched by the user. As such, the accuracy of displaying the relevant information can be improved by giving a high priority to displaying the relevant information of the resource having a higher matching degree.

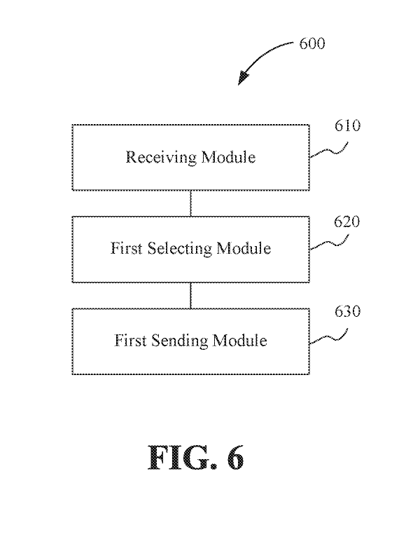

FIG. 6 is a block diagram an apparatus 600 for searching a resource, according to an exemplary embodiment of the present disclosure. The apparatus 600 may be applied in a server. As shown in FIG. 6, the apparatus 600 may include a receiving module 610, a first selecting module 620 and a first sending module 630.

The receiving module 610 is configured to receive at least one search character sent by an input program. The at least one search character is received when the input program is called by an application program running in a foreground in a terminal.

The first selecting module 620 is configured to select relevant information of a resource that matches the at least one search character received by the receiving module 610 from a resource library. The resource library is configured for storing the resource and the relevant information of the resource. The relevant information is configured for a user to identify and acquire the resource.

The first sending module 630 is configured to send the relevant information selected by the first selecting module 620 to the input program. The input program is configured for providing the relevant information to the user.

In the apparatus 600 for searching a resource provided by the present disclosure, relevant information of a resource that matches the received at least one search character is selected by a server from a resource library. The relevant information is received and provided to the user. The user can find the resource by only inputting at least one search character, without inputting a complete name of the resource in a search bar of the application program. This solves the problem of low resource searching efficiency due to that only when the user inputs a complete name of the resource in a search bar of the application program while searching resources, the server sends the resource that matches the name to the application program. Accordingly, the effect of improving the resource searching efficiency may be achieved.

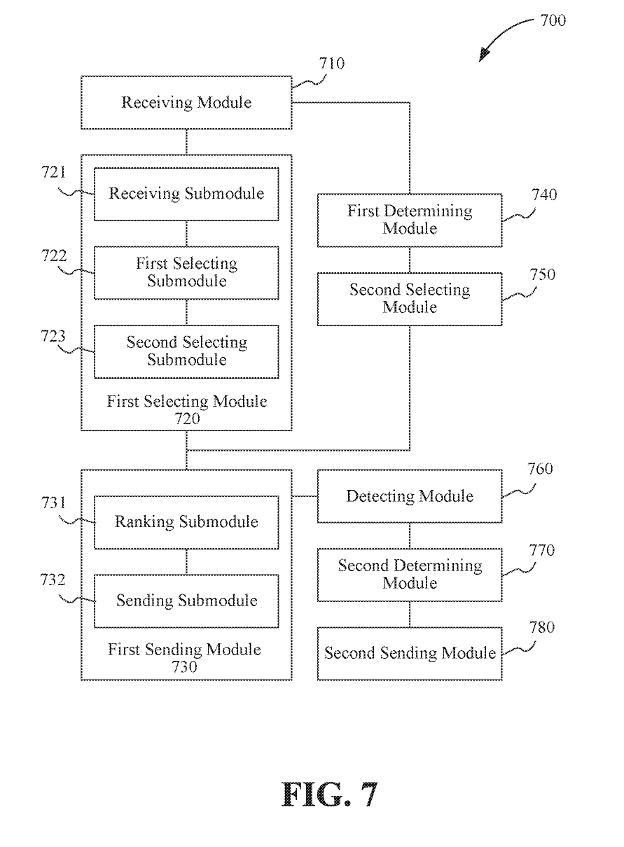

FIG. 7 is a block diagram of an apparatus 700 for searching a resource, according to another exemplary embodiment of the present disclosure. The apparatus 700 may be applied in a server. As shown in FIG. 7, the apparatus 700 may include a receiving module 710, a first selecting module 720 and a first sending module 730.

The receiving module 710 is configured to receive at least one search character sent by an input program. The at least one search character is received when the input program is called by an application program running in a foreground in a terminal.

The first selecting module 720 is configured to select relevant information of a resource that matches the at least one search character received by the receiving module 710 from a resource library. The resource library is configured for storing the resource and the relevant information of the resource. And the relevant information is configured for a user to identify and acquire the resource.

The first sending module 730 is configured to send the relevant information selected by the first selecting module 720 to the input program. The input program is configured for providing the relevant information to the user.

In some embodiments, the first selecting module 720 may include a receiving submodule 721, a first selecting submodule 722 and a second selecting submodule 723.

The receiving submodule 721 is configured to receive an identification of the application program calling the input program sent by the input program.

The first selecting submodule 722 is configured to select a resource library corresponding to the identification received by the receiving submodule 721 from the at least one resource library.

The second selecting submodule 723 is configured to select the relevant information that matches the at least one search character from the resource library selected by the first selecting submodule 722.

In some embodiments, the apparatus 700 may further include a first determining module 740 and a second selecting module 750.

The first determining module 740 is configured to, when there is no relevant information that matches the at least one search character in the selected resource library, determine a resource library corresponding to other application program which belongs to the same type with this application program according to the identification.

The second selecting module 750 is configured to select the relevant information that matches the at least one search character from the resource library determined by the first determining module 740.

In some embodiments, the apparatus 700 may further include a detecting module 760, a second determining module 770, and a second sending module 780.

The detecting module 760 is configured to detect whether a resource acquiring request sent by the input program is received. The resource acquiring request is generated by triggering an address of the resource displayed in an interface of the input program by the user of the input program. The resource acquiring request is configured for requesting the resource from the server.

The second determining module 770 is configured to, when the detecting module 760 detects that the resource acquiring request is received, determine a resource library corresponding to the address.

The second sending module 780 is configured to, when the resource library determined by the second determining module 770 is the resource library corresponding to the application program calling the input program, send the resource to the application program calling the input program. When the resource library is the resource library corresponding to other application program, the second sending module 780 is configured to send the resource to the other application program.

In some embodiments, the first sending module 730 may include a ranking submodule 731 and a sending submodule 732.

The ranking submodule 731 is configured to, when the relevant information of at least two resources is selected, rank respective relevant information according to an order from a high matching degree to a low matching degree between names of respective resources and the at least one search character.

The sending submodule 732 is configured to send the respective relevant information sequentially to the input program according to the order ranked by the ranking submodule 731.

In the apparatus 700 for searching a resource provided by the present disclosure, relevant information of a resource that matches the at least one search character is selected by the server from a resource library. The relevant information is received and provided to the user. The user can find the resource by only inputting at least one search character when searching resources, without inputting a complete name of the resource in a search bar of the application program. This solves the problem of low resource searching efficiency due to that only when the user inputs a complete name of the resource in a search bar of the application program, the server sends the resource that matches the name to the application program. As such, the effect of improving the resource searching efficiency may be achieved.

In addition, the server receives an identification of the application program calling the input program acquired by the input program, such that it is unnecessary for the server to search the relevant information of the resource from all the resource libraries, instead, the server only needs to select the resource library corresponding to the identification from the at least one resource library, and select the relevant information that matches the search character from the selected resource library. Accordingly, it reduces the resource consumed by searching the relevant information that matches the search character via the server.

In addition, the resources that match the search character are ranked according to the matching degrees via the server. The respective relevant information is displayed according to the ranked order via the input program. The larger the matching degree with the search character is, the larger the possibility that the resource is the resource searched by the user. The accuracy of displaying the relevant information can be improved by giving a high priority to displaying the relevant information of the resource having a higher matching degree.

In addition, when there is no relevant information that matches the search character in the selected resource library, a resource library corresponding to other application program which belongs to the same type with this application program is determined according to the identification. The relevant information that matches the search character is selected from the determined resource library. In this way, when there is no resource searched by the user in the resource library corresponding to the application program calling the input program, a resource library corresponding to other application program having the same type may be searched. This solves the problem that the server does not find the relevant information of the resource when there is no resource searched by the user in the resource library corresponding to the application program calling the input program. As such, the effects of searching the resources across platforms may be achieved and thus providing more resources to the user.

With respect to the apparatuses in the above exemplary embodiments, the specific manners for performing operations for individual modules therein have been described in detail in the methods, which will not be repeated herein.

In some embodiments, an apparatus is provided for performing the methods for searching a resource provided by the present disclosure. The apparatus may include a processor, and a memory for storing instructions executable by the processor.

The processor is configured to receive at least one search character input by a user when an input program is called by an application program running in a foreground in a terminal and send the at least one search character to a server. The server is configured for selecting relevant information of a resource that matches the at least one search character from a resource library, and for sending the relevant information to the input program. The resource library is configured for storing the resource and the relevant information of the resource. The relevant information is configured for the user to identify and acquire the resource. The processor is further configured to receive and provide the relevant information to the user.

In some embodiments, an apparatus is provided for performing the methods for searching a resource provided by the present disclosure. The apparatus may include a processor and a memory for storing instructions executable by the processor.

The processor is configured to receive at least one search character sent by an input program. The at least one search character is received when the input program is called by an application program running in a foreground in a terminal. The processor is further configured to select relevant information of a resource that matches the at least one search character from a resource library. The resource library is configured for storing the resource and the relevant information of the resource. The relevant information is configured for a user to identify and acquire the resource. And the processor is further configured to send the relevant information to the input program. The input program is configured for providing the relevant information to the user.

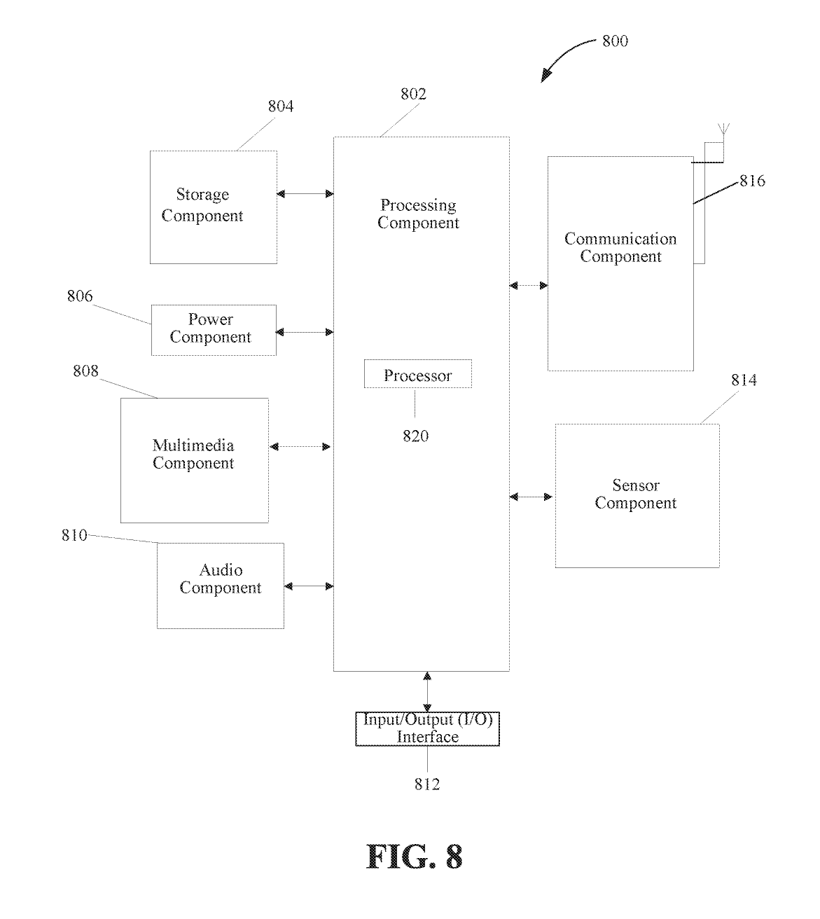

FIG. 8 is a block diagram of a terminal 800, according to an exemplary embodiment of the present disclosure.

Referring to FIG. 8, the terminal 800 may include one or more of the following components: a processing component 802, a storage component 804, a power component 806, a multimedia component 808, an audio component 810, an input/output (I/O) interface 812, a sensor component 814, and a communication component 816.

The processing component 802 typically controls overall operations of the terminal 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate interactions between the processing component 802 and other components. For instance, the processing component 802 may include a multimedia module to facilitate the interactions between the multimedia component 808 and the processing component 802.

The storage component 804 is configured to store various types of data to support the operations of the terminal 800. Examples of such data include instructions for any applications or methods operated on the terminal 800, contact data, phonebook data, messages, pictures, videos, etc. The storage component 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the terminal 800. The power component 806 may include a power management system, one or more power sources, and any other components associated with the generation, management, and distribution of power in the terminal 800.

The multimedia component 808 may include a screen providing an output interface between the terminal 800 and a user. In some embodiments, the screen may include a liquid crystal display (LCD) and a touch panel (TP). If the screen includes the touch panel, the screen may be implemented as a touch screen to receive input signals from the user. The touch panel may include one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 may include a front camera and/or a rear camera. The front camera and the rear camera may receive an external multimedia datum while the terminal 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 may include a microphone (“MIC”) configured to receive an external audio signal when the terminal 800 is in an operation mode, such as a call mode, a recording mode, and a voice recognition mode. The received audio signal may be further stored in the storage component 804 or transmitted via the communication component 816. In some embodiments, the audio component 810 may further include a loudspeaker for outputting the audio signal.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 may include one or more sensors to provide status assessments of various aspects of the terminal 800. For instance, the sensor component 814 may detect an open/closed status of the terminal 800, relative positioning of components, e.g., the display and the keypad, of the terminal 800, a change in position of the terminal 800 or a component of the terminal 800, a presence or absence of user contact with the terminal 800, an orientation or an acceleration/deceleration of the terminal 800, and a change in temperature of the terminal 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate wired and/or wireless communications between the terminal 800 and other devices. The terminal 800 can access a wireless network based on a communication standard, such as WiFi, 2G or 3G or a combination thereof. In some embodiments, the communication component 816 may receive a broadcast signal from an external broadcast management system via a broadcast channel or broadcast associated information. In some embodiments, the communication component 816 may further include a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In some embodiments, the terminal 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In some embodiments, a non-transitory computer-readable storage medium having instructions stored thereon is provided, such as the storage component 804 having instructions stored thereon. Those instructions are executable by the processor 820 in the terminal 800, for performing the above-described methods. For example, the non-transitory computer-readable storage medium may be a ROM, a RAM, a CD-ROM, a magnetic tape, a floppy disc, an optical data storage device, and the like.

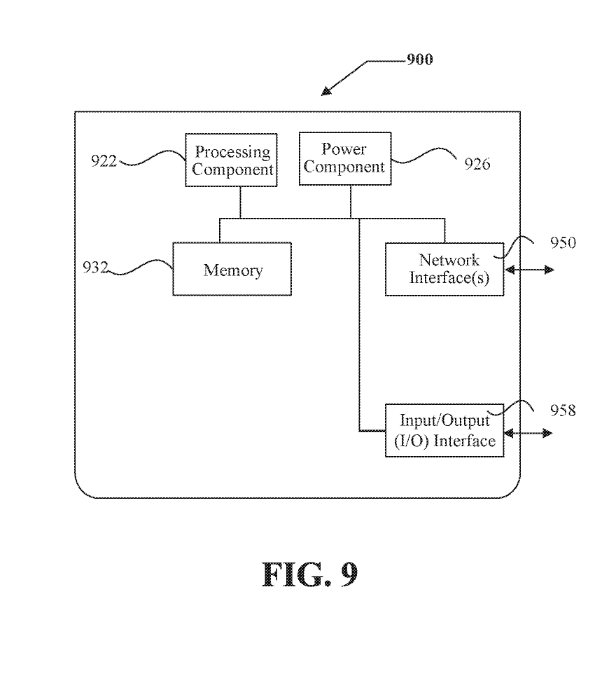

FIG. 9 is a block diagram of a server 900, according to an exemplary embodiment. Referring to FIG. 9, the server 900 may include a processing component 922 that further includes one or more processors, and memory resources represented by a memory 932 for storing instructions executable by the processing component 922, such as application programs. The application programs stored in the memory 932 may include one or more modules each corresponding to a set of instructions. Further, the processing component 922 is configured to execute the instructions to perform the above described methods for searching a resource.

The server 900 may also include a power component 926 configured to perform power management of the server 900, wired or wireless network interface(s) 950 configured to connect the server 900 to a network, and an input/output (I/O) interface 958. The server 900 may operate based on an operating system stored in the memory 932, such as Windows Server™, Mac OS X™, Unix™, Linux™, FreeBSD™, or the like.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for searching a resource, applied in a terminal, the method comprising:
receiving at least one search character input by a user when an input program is called by an application program running in a foreground in the terminal;
sending the at least one search character to a server, the server being configured for selecting from a resource library relevant information of a resource that matches the at least one search character, and sending the relevant information to the input program, the resource library being configured for storing the resource and the relevant information of the resource, the relevant information being configured for the user to identify and acquire the resource; and
receiving the relevant information from the server and providing the relevant information to the user.

2. The method of claim 1, wherein the providing the relevant information to the user comprises:
displaying the relevant information in an interface of the input program.

3. The method of claim 2, wherein the displaying the relevant information in the interface of the input program comprises:
displaying the relevant information in an adjacent area of a candidate word generated by the input program according to the at least one search character, the relevant information including at least a name of the resource and an address of the resource.

4. The method of claim 3, further comprising:
when the relevant information includes the address of the resource, detecting whether a first operation instruction generated by triggering the address is received; and
when the first operation instruction is received, sending a resource acquiring request carrying the address to the server, the resource acquiring request being configured for requesting the resource from the server.

5. The method of claim 2, wherein when the relevant information includes relevant information of at least two resources, the method further comprises:
receiving the relevant information of the at least two resources; and
displaying the relevant information of the at least two resources sequentially according to a ranked order, the ranked order being obtained by ranking relevant information of the at least two resources by the server according to an order from a high matching degree to a low matching degree between names of the at least two resources and the at least one search character.

6. The method of claim 1, further comprising:
acquiring an identification of the application program calling the input program; and
sending the identification of the application program to the server, the server being configured for selecting a resource library corresponding to the identification of the application program from at least one resource library, and selecting the relevant information that matches the at least one search character from the selected resource library.

7. A method for searching a resource, applied in a server, the method comprising:
receiving at least one search character sent by an input program in a terminal, the at least one search character being received when the input program is called by an application program running in a foreground in the terminal;
selecting relevant information of a resource that matches the at least one search character from a resource library, the resource library being configured for storing the resource and the relevant information of the resource, and the relevant information being configured for a user to identify and acquire the resource; and
sending the relevant information to the input program, the input program being configured for providing the relevant information to the user.

8. The method of claim 7, wherein the selecting relevant information of the resource that matches the at least one search character from a resource library comprises:
receiving an identification of the application program calling the input program sent by the input program;
selecting a resource library corresponding to the identification from at least one resource library; and
selecting the relevant information that matches the at least one search character from the selected resource library.

9. The method of claim 8, wherein the application program calling the input program is a first application program, the method further comprising:
when there is no relevant information that matches the at least one search character in the selected resource library, determining a resource library corresponding to a second application program of a same type with the first application program according to the identification; and
selecting the relevant information that matches the at least one search character from the determined resource library.

10. The method of claim 9, further comprising:
detecting whether a resource acquiring request sent by the input program is received, the resource acquiring request being generated by triggering an address of the resource displayed in an interface of the input program, the resource acquiring request being configured for requesting the resource from the server;
when the resource acquiring request is received, determining a resource library corresponding to the address; and
when the determined resource library corresponding to the address is the resource library corresponding to the application program calling the input program, sending the resource to the application program calling the input program; and when the determined resource library corresponding to the address is the resource library corresponding to the second application program, sending the resource to the second application program.

11. A terminal, comprising:
a processor; and
a memory for storing instructions executable by the processor;
wherein the processor is configured to:
receive at least one search character input by a user when an input program is called by an application program running in a foreground in the terminal;
send the at least one search character to a server, the server being configured for selecting from a resource library relevant information of a resource that matches the at least one search character, and sending the relevant information to the input program, the resource library being configured for storing the resource and the relevant information of the resource, the relevant information being configured for the user to identify and acquire the resource; and
receive the relevant information from the server and provide the relevant information to the user.

12. The terminal of claim 11, wherein the processor is further configured to:
display the relevant information in an interface of the input program.

13. The terminal of claim 12, wherein the processor is further configured to:
display the relevant information in an adjacent area of a candidate word generated by the input program according to the at least one search character, the relevant information including at least a name of the resource and an address of the resource.

14. The terminal of claim 13, wherein the processor is further configured to:
when the relevant information includes the address of the resource, detect whether a first operation instruction generated by triggering the address is received; and
when it is detected that the first operation instruction is received, send a resource acquiring request carrying the address to the server, the resource acquiring request being configured for requesting the resource from the server.

15. The terminal of claim 12, wherein when the relevant information includes relevant information of at least two resources, the processor is further configured to:
receive the relevant information of the at least two resources; and
display the relevant information of the at least two resources sequentially according to a ranked order, the ranked order being obtained by ranking the relevant information of the at least two resources by the server according to an order from a high matching degree to a low matching degree between names of the at least two resources and the at least one search character.

16. The terminal of claim 11, wherein the processor is further configured to:
acquire an identification of the application program calling the input program; and
send the acquired identification of the application program to the server, the server being configured for selecting a resource library corresponding to the identification of the application program from at least one resource library, and selecting the relevant information that matches the at least one search character from the selected resource library.

17. A server, comprising:
a processor; and
a memory for storing instructions executable by the processor;
wherein the processor is configured to:
receive at least one search character sent by an input program in a terminal, the at least one search character being received when the input program is called by an application program running in a foreground in the terminal;
select relevant information of a resource that matches the at least one search character from a resource library, the resource library being configured for storing the resource and the relevant information of the resource, and the relevant information being configured for a user to identify and acquire the resource; and
send the relevant information to the input program, the input program being configured for providing the relevant information to the user.

18. The server of claim 17, wherein the processor is further configured to:
receive an identification of the application program calling the input program sent by the input program;
select a resource library corresponding to the received identification from at least one resource library; and
select the relevant information that matches the at least one search character from the selected resource library.

19. The server of claim 18, wherein the application program calling the input program is a first application program, and the processor is further configured to:
when there is no relevant information that matches the at least one search character in the selected resource library, determine a resource library corresponding to a second application program of a same type with the first application program according to the identification; and
select the relevant information that matches the at least one search character from the determined resource library.

20. The server of claim 19, wherein the processor is further configured to:
detect whether a resource acquiring request sent by the input program is received, the resource acquiring request being generated by triggering an address of the resource displayed in an interface of the input program, the resource acquiring request being configured for requesting the resource from the server;
when it is detected that the resource acquiring request is received, determine a resource library corresponding to the address; and
when the determined resource library corresponding to the address is the resource library corresponding to the application program calling the input program, send the resource to the application program calling the input program; and when the determined resource library corresponding to the address is the resource library corresponding to the second application program, send the resource to the second application program.
